(19) United States
(12) Patent Application Publication
(10) Pub. No.: US 2009/0084919 A1
(43) Pub. Date: Apr. 2, 2009

(54) SLIDING BOLLARD BRACKET MOUNT

(76) Inventors: David U. Hillstrom, Calumet, MI (US); Thomas Pilarczyk, Brighton, MI (US)

Correspondence Address: HARNESS, DICKEY & PIERCE, P.L.C., P.O. BOX 828, BLOOMFIELD HILLS, MI, 48303, US

(21) Appl. No.: 11/864,200

(22) Filed: Sep. 28, 2007

(51) Int. Cl. F16M 13/02; A47F 5/00; G09F 19/00

(52) U.S. Cl. 248/309.1; 248/200; 40/606.01

(57) ABSTRACT

A mount for attaching a sign to a support structure includes a brace having a web and transversely extending first and second flanges each having a plurality of apertures, individual ones of the apertures of both the first and second flanges being coaxially aligned. A bracket includes a bracket web and transversely extending first and second bracket flanges. The first and second bracket flanges are slidably received between the first and second brace flanges. The first and second bracket flanges have elongated apertures with individual ones of the elongated apertures of both the first and second bracket flanges being coaxially aligned. A releasable mounting configuration includes a fastener inserted through individual ones of the elongated apertures which are coaxially aligned with individual apertures of both the first and second flanges. A flexible strap connected to the bracket fixedly connects the mount to a bollard post.

### FIELD

The present disclosure relates to brackets used in a mount to support advertisement signs to support members such as posts of bollards.

### BACKGROUND

The statements in this section merely provide background information related to the present disclosure and may not constitute prior art.

Advertising is an important component of many point of purchase properties such as gas filling stations. These locations utilize a variety of devices to mount and display advertising on the various structures on the property. Some of these assemblies may be permanently fixed advertising secured to the building structure at the point of purchase location. Other assemblies may be temporary displays releasably secured to fixtures at the point of purchase location.

One opportunity for display of temporary advertising are the bollards or posts which extend upwardly from the ground to protect various building structures or fixtures at the point of purchase location. For example, bollards are utilized around the filling station islands to protect the filling station pumps against impact by the vehicles driving by and utilizing the gas pumps.

Presently, advertising displays that are rigidly secured to the bollards do not allow for adjustment when the size of the advertising media change. This lack of adjustment can result in the new advertising media being extended into the path of travel of entering or exiting vehicles. In addition, spacing between bollards commonly varies both between bollard designs at a given station, and between bollard designs used at different filling stations. The lack of adjustability can prevent installation of advertising at some locations.

### SUMMARY

According to several embodiments, a mount for attaching a sign to a support structure includes a U-shaped brace having a web and transversely extending first and second flanges each having a plurality of apertures. Individual ones of the apertures of both the first and second flanges are coaxially aligned. At least one bracket has a bracket web and transversely extending first and second bracket flanges. The first and second bracket flanges are adapted to be slidably received between the first and second flanges of the brace. Each of the first and second bracket flanges has a plurality of elongated apertures, with individual ones of the elongated apertures of both the first and second bracket flanges being coaxially aligned. A releasable mounting configuration having a fastener inserted through individual ones of the elongated apertures which are coaxially aligned with the coaxially aligned individual ones of the apertures of both the first and second flanges.

According to additional embodiments, a mount for attaching a sign to a support structure post includes a sign structure. A brace is fixedly connected to the sign structure, the brace having first and second parallel flanges each having a plurality of apertures. Individual ones of the apertures of both the first and second flanges are coaxially aligned. The first and second flanges of the brace are oriented facing away from the sign structure. A bracket has a bracket web and first and second bracket flanges transversely extending from the web. The first and second bracket flanges are adapted to be slidably received between the first and second flanges of the brace. Each of the first and second bracket flanges includes a plurality of elongated apertures, with individual ones of the elongated apertures of both the first and second bracket flanges being coaxially aligned.

According to still other embodiments, each of the first and second bracket flanges have a notch. The notch of the first bracket flange is coaxially aligned with the notch of the second bracket flange such that a support structure post is received within the notch of both the first and second bracket flanges when the mount is engaged to the post.

According to yet other embodiments, a method is provided for assembling a mount for attaching a sign to a support structure, the mount including a brace with a web and first and second flanges, and a bracket having a bracket web and first and second bracket flanges.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a rear perspective view of a bollard sign assembly of the present disclosure adapted for mounting to a 2-post bollard;

FIG. 2 is a front perspective view of a U-shaped brace of the present disclosure;

FIG. 3 is a front elevational view of a preformed plate prior to bending to create the brace of FIG. 2;

FIG. 4 is a front elevational view of the brace of FIG. 2;

FIG. 5 is a top plan view of the brace of FIG. 2;

FIG. 6 is an end elevational view of the brace of FIG. 2;

FIG. 7 is a rear perspective view of a sliding bracket of the present disclosure;

FIG. 8 is a front elevational view of a preformed plate prior to bending to create the sliding bracket of FIG. 7;

FIG. 9 is a front elevational view of the sliding bracket of FIG. 7;

FIG. 10 is a top plan view of the sliding bracket of FIG. 7;

FIG. 11 is an end elevational view of the sliding bracket of FIG. 7;

FIG. 12 is a rear perspective view of a sign frame adapted to be supported by a bollard sign assembly of the present disclosure;

FIG. 13 is a rear perspective assembly view of the sign frame of FIG. 12 further including the brace of FIG. 2;

FIG. 14 is a rear perspective assembly view of the configuration of FIG. 13 further including first and second sliding brackets of the present disclosure;

FIG. 15 is a top plan view of the bollard sign assembly of FIG. 1 mounted to a maximum spaced 2-post bollard;

FIG. 16 is a top plan view of the bollard sign assembly of FIG. 1 mounted to a minimum spaced 2-post bollard;

FIG. 17 is a rear perspective view of a bollard sign assembly of the present disclosure adapted for mounting to a 1-post bollard; and

FIG. 18 is an exploded rear perspective assembly view of the configuration of FIG. 17.

### DETAILED DESCRIPTION

The following description is merely exemplary in nature and is not intended to limit the present disclosure, application, or uses. It should be understood that throughout the drawings, corresponding reference numerals indicate like or corresponding parts and features.

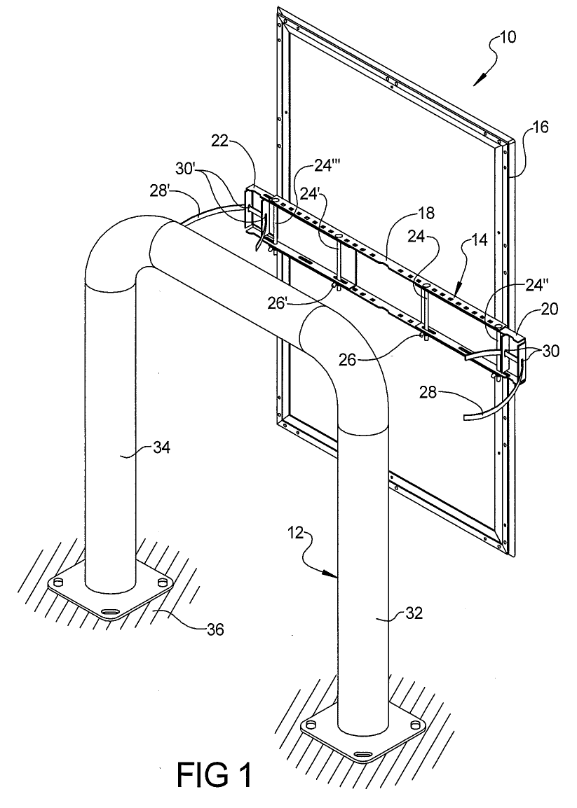

Referring to FIG. 1, a bollard mount or sign assembly 10 is connected to a bollard 12 using a bracket assembly 14 of the present disclosure. Bracket assembly 14 is fastened to a sign frame 16 which can display items for sale at a business location for example.

Bracket assembly 14 includes a U-shaped brace 18 having each of a first and second sliding bracket 20, 22 disposed within a space envelope (between opposed flanges) of U-shaped brace 18. First and second sliding brackets 20, 22 are releasably connectable to U-shaped brace 18 using a plurality of fasteners 24 such as studs or bolts which can be fixed using a plurality of nuts 26. A flexible strap 28, 28′ is looped through aligned aperture pairs 30, 30′ created in each of first and second sliding brackets 20, 22. Flexible straps 28 can be made from metal such as stainless steel, plastic, or a composite material. Flexible straps 28 are looped through the aligned aperture pairs 30, 30′ and also about each of a first bollard post 32 and the second bollard post 34 of bollard 12 to releasably fix bollard sign assembly 10 to bollard 12. Bollard 12 is commonly fixedly connected to a ground surface 36 which can also include items such as a concrete pad, a wooden support structure (not shown) or the like.

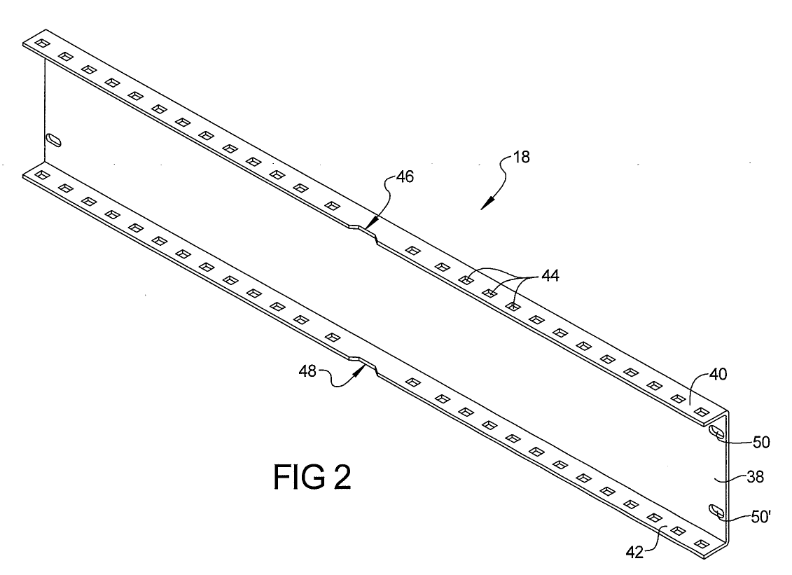

Referring to FIG. 2, U-shaped brace 18 includes a brace web 38 having a first and a second opposed brace flange 40, 42 extending substantially parallel to each other and transverse to the brace web 38. Brace flanges 40, 42 can be angled toward or away from each other within the definition of “substantially parallel”. A plurality of apertures 44 are formed in co-axial alignment along each of first and second brace flanges 40, 42. Individual ones of apertures 44 of first brace flange 40 are co-axially aligned with a corresponding one of the apertures 44 of second brace flange 42, thereby allowing fasteners 24 (described in reference to FIG. 1) to pass through each of first and second brace flanges 40, 42.

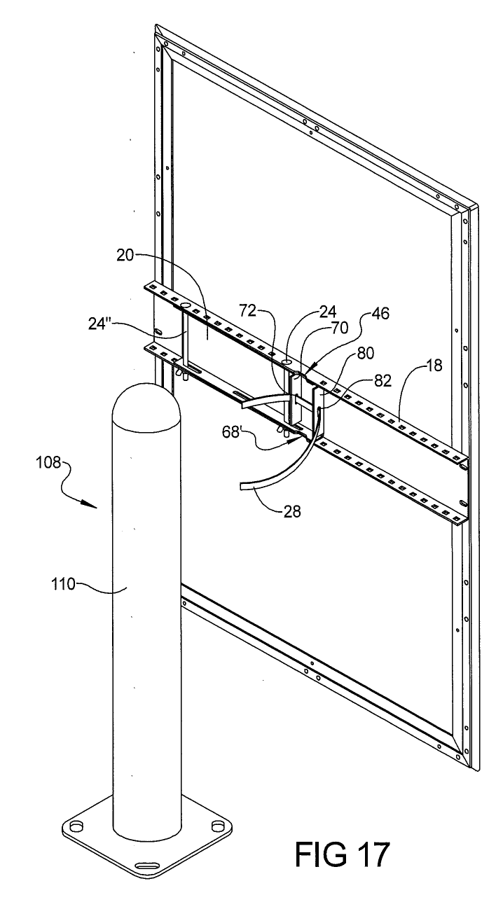

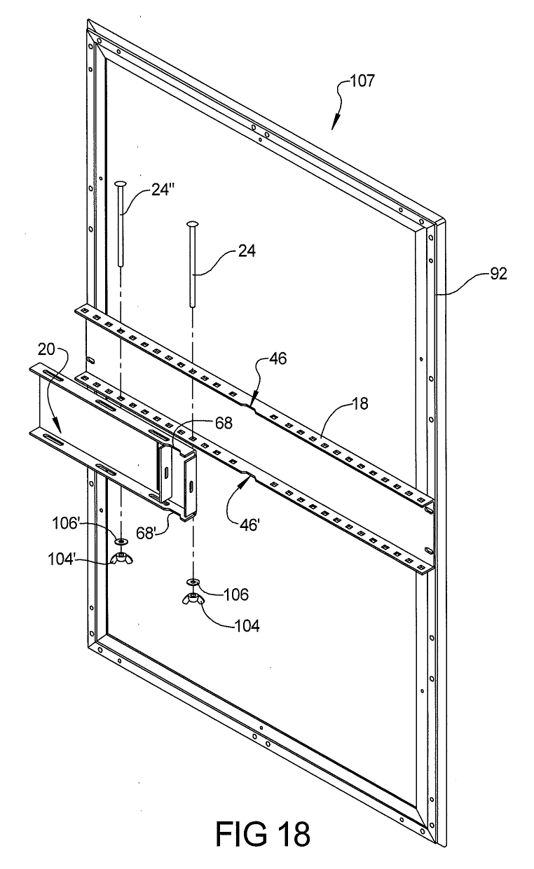

U-shaped brace 18 further includes each of a first and a second notch 46, 48 each formed on one of first and second brace flanges 40, 42 respectively. The purpose for first and second notches 46, 48 will be described in reference to FIG. 17. A plurality of elongated apertures 50 are created at opposed ends of brace web 38 with a first one of the elongated apertures 50 positioned proximate to first brace flange 40 and a second one of the elongated apertures 50′ positioned proximate to second brace flange 42. Material for U-shaped brace 18 can be a metal such as steel or aluminum and can further include a coating such as a powdered coating, paint, or the like applied to resist corrosion and/or to provide a color commensurate with the particular business entity using bollard sign assembly 10.

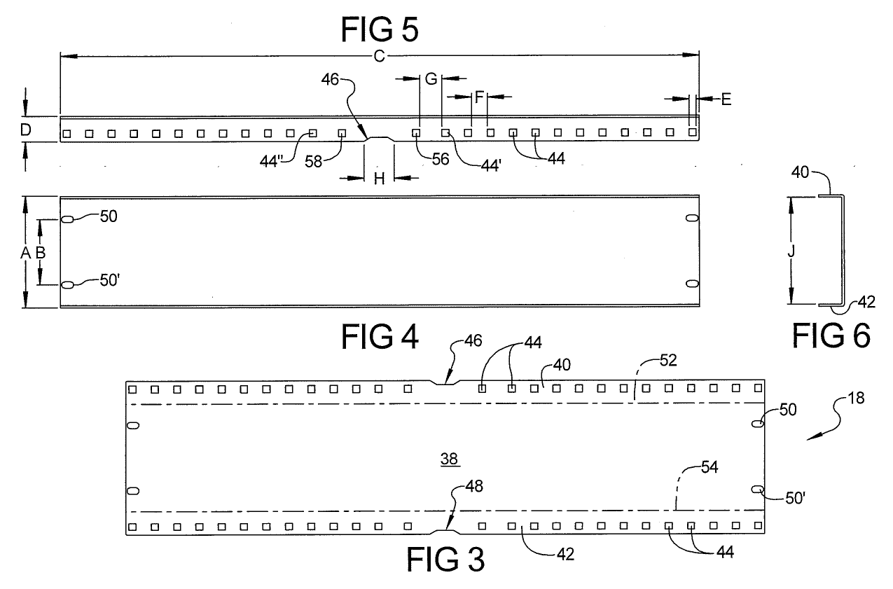

Referring now generally to FIGS. 3 through 6, U-shaped brace 18 is formed initially as a substantially flat plate shown in FIG. 3 having each of a first and second bend line 52, 54 demarking a location to bend each of first and second brace flanges 40, 42 to reorient the brace flanges with respect to brace web 38. Prior to this bending or shaping operation, the various apertures 44 and 50 are created, for example by a punching or piercing operation. First and second notches 46, 48 are also created at this time using a similar operation.

U-shaped brace 18 has a brace width “A”, an aperture spacing “B”, a brace length “C”, a flange depth “D”, and an aperture dimension “E”. Aperture dimension “E” according to several embodiments represents both a width and a height of a substantially rectangular-shaped aperture. According to additional embodiments, aperture dimension “E” can also represent a diameter of a substantially circular aperture. Apertures 44 are commonly separated by a first spacing dimension “F” with the exception of a second spacing dimension “G” separating an aperture 44′ from an aperture 56, and separating an aperture 44″ from an aperture 58. Each of first and second notches 46, 48 are coaxial with each other and each have a notch width “H”. A flange clearance dimension “J” between first and second brace flanges 40, 42 is predetermined to allow first and second sliding brackets 20, 22 (shown in reference to FIG. 1) to be slidably received between first and second brace flanges 40, 42.

According to several embodiments of the present disclosure, brace width “A” is approximately 5.0 in (12.7 cm), aperture spacing “B” is approximately 3.0 in (7.62 cm), brace length “C” is approximately 28.62 in (72.7 cm), flange depth “D” is approximately 1.12 in (2.84 cm), and aperture dimension “E” is approximately 0.31 in (0.79 cm). In addition, according to several embodiments, first spacing dimension “F” for apertures 44 is approximately 0.69 in (1.75 cm), second spacing dimension “G” is approximately 1.03 in (2.62 cm), notch width “H” is approximately 1.22 in (3.10 cm), and flange clearance dimension “J” is approximately 4.88 in (12.39 cm). These dimensions are provided for example only, as they can vary at the discretion of the manufacturer to accommodate multiple sizes of bollard sign assembly 10.

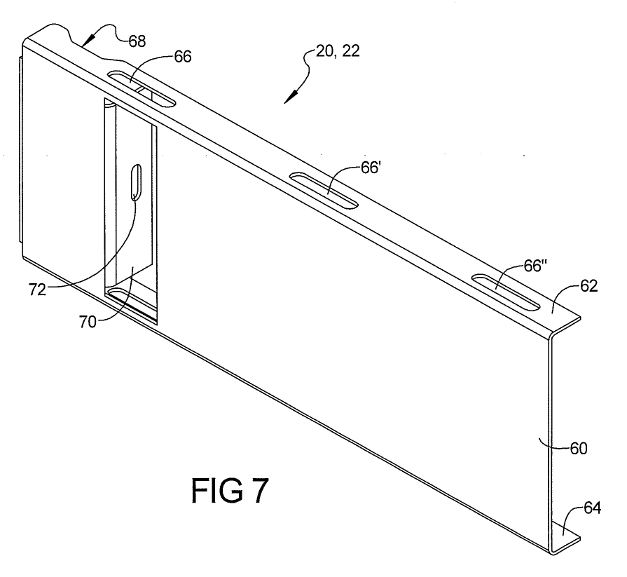

Referring to FIG. 7, each of the first and second sliding brackets 20, 22 are identically constructed, therefore the following information applies equally to both first and second sliding brackets 20, 22. Each sliding bracket includes a bracket web 60 having a first bracket flange 62 and a second bracket flange 64 substantially transversely oriented with respect to bracket web 60, and each extending from a similar side of bracket web 60. A plurality of elongated apertures 66 are created in each of first and second bracket flanges 62, 64 and individual ones of the elongated apertures 66 are co-axially aligned between the first and second bracket flanges 62, 64. In the embodiment shown in FIG. 7, three elongated apertures 66 designated 66, 66′, and 66″ are shown, however this quantity is not limiting to the disclosure. A bracket notch 68, 68′ (similar to first and second notches 46, 48 created in U-shaped brace 18) is also created on each of first and second bracket flanges 62, 64 and co-axially aligned with each other.

Each of the first and second sliding brackets 20, 22 further include a first bracket leg 70 which is bent or otherwise formed transverse to bracket web 60 and each of first and second bracket flanges 62, 64. An elongated strap receiving aperture 72 is created in first bracket leg 70. Elongated strap receiving aperture 72 defines one of the aligned apertures of aligned aperture pairs 30 described in reference to FIG. 1.

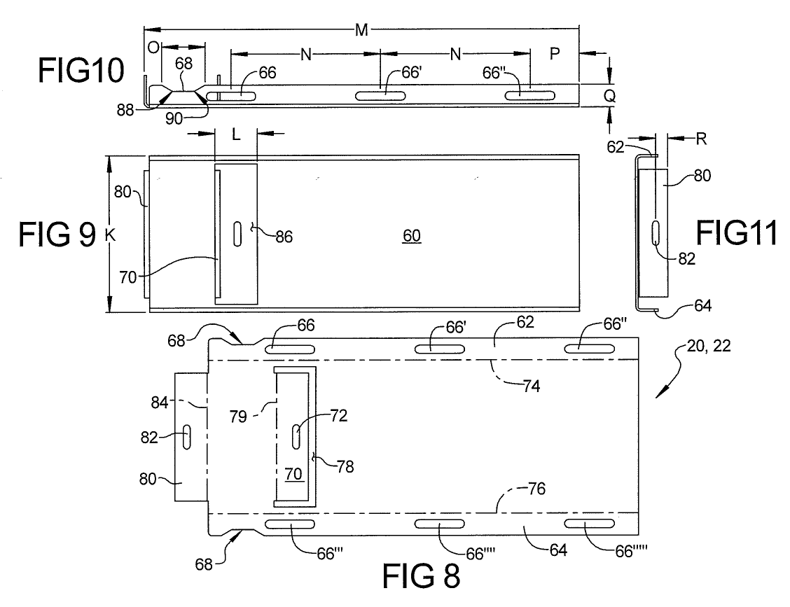

Referring to FIGS. 8 through 11, a first and a second flange bend line 74, 76 defines a bend location to create each of first and second bracket flanges 62, 64. Similar to U-shaped brace 18, each of first and second sliding brackets 20, 22 are also initially formed as shown in FIG. 8 from a substantially flat piece of plate or roll material having the plurality of features stamped or punched to create the configuration shown in FIG. 8. These include each of the apertures 66, elongated strap receiving aperture 72, and bracket notches 68, 68′. First bracket leg 70 is formed by first punching or otherwise creating a clearance aperture 78. First bracket leg 70 can then be bent along a leg bend line 79 to be transverse to the web 60. A second bracket leg 80 extends from an end of the plate material shown in FIG. 8. An elongated strap receiving aperture 82 which is co-axially aligned with elongated strap receiving aperture 72 is created by punching or otherwise forming through second bracket leg 80. Second bracket leg 80 can then be bent or formed along a second leg bend line 84 and is oriented substantially parallel to first bracket leg 70.

After first bracket leg 70 is formed, a cavity 86 is created through bracket web 60. Each of first bracket leg 70 and second bracket leg 80 after bending are positioned substantially parallel to each other and transverse to bracket web 60. Each of the bracket notches 68, 68′ are defined by first and second corners 88, 90. Both first and second bracket legs 70, 80 as shown in FIG. 11 extend beyond a total flange length of first and second bracket flanges 62, 64, providing access to each of elongated strap receiving apertures 72, 82 and allowing first and second bracket legs 70, 80 to contact a bollard post.

According to several embodiments of the present disclosure, a bracket total width “K” is approximately 4.82 in (12.24 cm), a cavity width “L” is approximately 1.25 in (3.17 cm), a bracket length “M” is approximately 13.12 in (33.32 cm), and an aperture spacing dimension “N” is approximately 4.5 in (11.43 cm). Also according to several embodiments of the present disclosure, a notch width “O” of bracket notches 68 is approximately 1.38 in (3.5 cm), an aperture locating dimension “P” is approximately 1.50 in (3.81 cm), a flange depth “Q” is approximately 0.75 in (1.9 cm), and an aperture locating dimension “R” for both elongated strap receiving apertures 72, 82 is approximately 0.38 in (0.96 cm). As previously noted, dimensions given herein do not limit the bollard assemblies of the present disclosure.

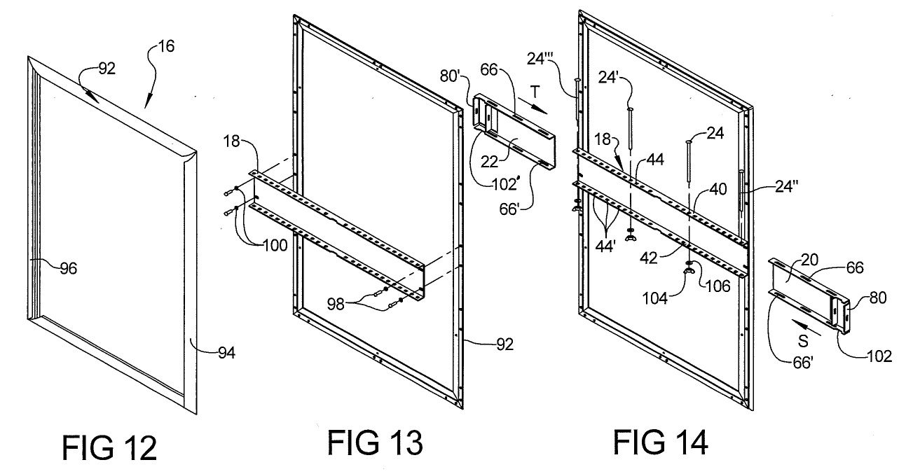

Referring to FIG. 12, sign frame 16 adapted for use with the present disclosure includes a sign outer frame 92 which can further include each of a first rotatable frame member 94 and a second rotatable frame member 96. First and second rotatable frame members 94, 96 can be biased to allow for manual installation and removable of a sign or placard used in advertising a desired product.

Referring to FIG. 13, the U-shaped brace 18 is fixedly mounted to a rear surface of sign frame 16 using a plurality of fasteners 98 such as screws or bolts which each can be installed with one of a plurality of washers 100. U-shaped brace 18 can be vertically positioned at any location along the sign outer frame 92 corresponding with pre-formed mounting holes, or fasteners 98 can be of a self-tapping design allowing brace 18 to be located at any vertical location. Brace 18 provides a balanced position for support against a wind force when positioned as shown mounted at the proximate mid-point of sign outer frame 92.

Referring to FIG. 14, following the installation of U-shaped brace 18, each of the first and second sliding brackets 20, 22 are then installed. First sliding bracket 20 can be installed by sliding in the installation direction “S” having a bracket leg end 102 including second bracket leg 80 outwardly and rearwardly facing as shown. Second sliding bracket 22 can be similarly installed by sliding in an installation direction “T” having a bracket leg end 102′ including second bracket leg 80′ outwardly and rearwardly facing as shown. First and second sliding brackets 20, 22 are releasably fixed in the desired position along brace 18 by insertion of fasteners 24 through the individual apertures 44 of first brace flange 40, through individual ones of the elongated apertures 66, 66′ of the first and second sliding brackets 20, 22, and then through apertures 44 of the second brace flange 42. Following insertion of the fasteners 24, nuts 104 and washers 106 can be installed to complete the installation.

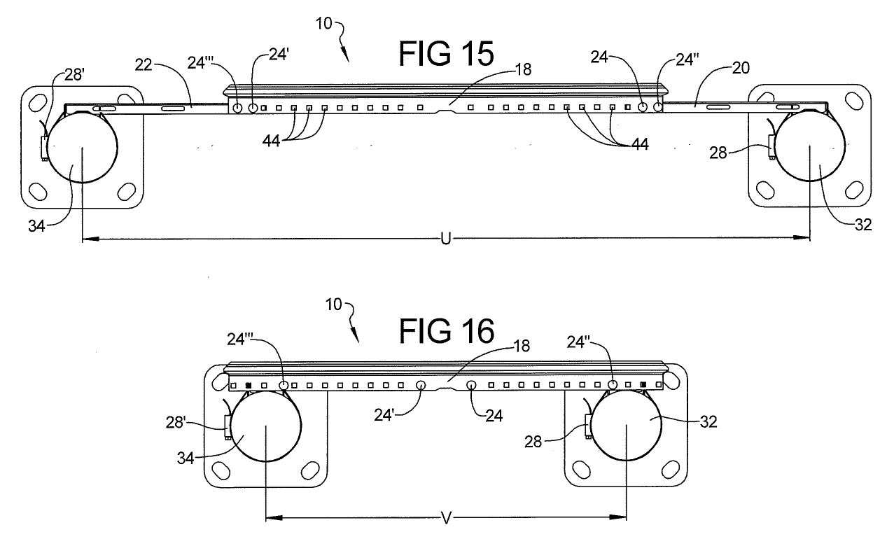

Referring now to FIG. 15, bollard sign assemblies 10 of the present disclosure can accommodate bollard designs with varying distances between the bollard posts. As shown in FIG. 15, a maximum post spacing dimension “U” is provided by extending first and second sliding brackets 20, 22 outwardly from U-shaped brace 18 to the maximum extent by inserting fasteners 24, 24″ as shown through first sliding bracket 20 and inserting fasteners 24′, 24′″ as shown through second sliding bracket 22 such that the fasteners as pairs 24, 24″ and 24′, 24′″ are positioned proximate to each other, allowing maximum extension of first and second sliding brackets 20, 22. Straps 28, 28′ are then fastened about each of first and second bollard posts 32, 34 to complete the installation of bollard sign assembly 10.

Referring to FIG. 16, a minimum post spacing dimension “V” is provided by the configuration shown which has first and second sliding brackets 20, 22 received completely within a space envelope of U-shaped brace 18 such that fasteners 24, 24′ are positioned as close together as possible. Similar to the installation shown in FIG. 15, the minimum post spacing dimension “V” and the installation of bollard sign assembly 10 is completed by fixing flexible straps 28, 28′ about each of first and second bollard posts 32, 34. It will be obvious that multiple spacing dimensions varying between minimum post spacing dimension “V” shown in FIG. 16 and maximum post spacing dimension “U” shown in FIG. 15 can be provided by bollard sign assembly 10 using the multiple locations of apertures 44 in U-shaped brace 18.

Referring to FIGS. 17 and 18, according to additional embodiments of the present disclosure a bollard sign assembly 107 is adapted for use on a bollard 108 having a single post 110. Bollard sign assembly 107 is modified from bollard sign assembly 10 through the use of only one of the first or second sliding brackets 20 or 22. In the example shown, first sliding bracket 20 is used however the details of second sliding bracket 22 if used would be similar. First sliding bracket 20 is positioned with bracket notches 68, 68′ (only bracket notch 68′ is clearly visible in FIG. 17) aligned with first and second notches 46, 48 (only first notch 46 is clearly visible in FIG. 17). This orientation of first sliding bracket 20 centers first and second bracket legs 70, 80 with respect to U-shaped brace 18. Flexible strap 28 is then inserted through each of elongated strap receiving apertures 72, 82 and fastened about post 110 to complete the installation. Bollard sign assembly 107 can also be modified from the orientation shown in FIG. 17 by sliding or repositioning first sliding bracket 20 with respect to U-shaped brace 18 from that shown and fastening first sliding bracket 20 in alternate locations along U-shaped brace 18 using fasteners 24 inserted through alternate ones of the apertures 44.

What is claimed is:

1. A mount for attaching a sign to a support structure, the mount comprising:
a U-shaped brace having a web and transversely extending first and second flanges each having a plurality of apertures, individual ones of the apertures of both the first and second flanges being coaxially aligned;
at least one bracket having a bracket web and transversely extending first and second bracket flanges, the first and second bracket flanges adapted to be slidably received between the first and second flanges of the brace and each of the first and second bracket flanges having a plurality of elongated apertures, with individual ones of the elongated apertures of both the first and second bracket flanges being coaxially aligned; and
a releasable mounting configuration having a fastener inserted through individual ones of the elongated apertures which are coaxially aligned with the coaxially aligned individual ones of the apertures of both the first and second flanges.

2. The mount of claim 1, further comprising a first bracket leg of the bracket oriented transverse to both the bracket web and the first and second bracket flanges, the first bracket leg including a first bracket leg elongated aperture.

3. The mount of claim 2, further comprising a second bracket leg of the bracket oriented transverse to both the bracket web and the first and second bracket flanges and substantially parallel to the first bracket leg, the second bracket leg including a second bracket leg elongated aperture.

4. The mount of claim 3, further comprising a flexible strap insertable through both the first and second bracket leg elongated apertures and adapted to be fixedly connected to a bollard post.

5. The mount of claim 3, wherein the first and second bracket legs each extend outwardly beyond both the first and second bracket flanges such that free ends of the first and second bracket legs contact a bollard post to help retain the mount in a fixed position with respect to the bollard post.

6. The mount of claim 1, wherein the releasable mounting configuration is adjustable having the elongated apertures of the at least one bracket positioned to align with different ones of the coaxially aligned individual ones of the apertures of both the first and second flanges.

7. The mount of claim 1, wherein the at least one bracket comprises a first and a second bracket, each oppositely slidably received within the first and second flanges of the brace and each oppositely extendable beyond the brace.

8. The mount of claim 1, further comprising a sign structure adapted to retain the sign, the brace being fixedly connected to the sign structure.

9. A mount for attaching a sign to a support structure post, the mount comprising:
a sign structure;
a brace fixedly connected to the sign structure, the brace having first and second parallel flanges each having a plurality of apertures, individual ones of the apertures of both the first and second flanges being coaxially aligned, the first and second flanges of the brace oriented facing away from the sign structure; and
a bracket having a bracket web and first and second bracket flanges transversely extending from the web, the first and second bracket flanges adapted to be slidably received between the first and second flanges of the brace and each of the first and second bracket flanges having a plurality of elongated apertures, with individual ones of the elongated apertures of both the first and second bracket flanges being coaxially aligned.

10. The mount of claim 9, further comprising a releasable mounting configuration having a fastener inserted through individual ones of the elongated apertures which are coaxially aligned with the coaxially aligned individual ones of the apertures of both the first and second flanges.

11. The mount of claim 10, further comprising:
a first bracket leg of the bracket oriented transverse to both the bracket web and the first and second bracket flanges, the first bracket leg including a first bracket leg elongated aperture; and
a second bracket leg of the bracket oriented transverse to both the bracket web and the first and second bracket flanges and substantially parallel to and side-by-side with the first bracket leg, the second bracket leg including a second bracket leg elongated aperture.

12. The mount of claim 11, further comprising a flexible strap insertable through both the first and second bracket leg elongated apertures and adapted to be fixedly connected to the support structure post.

13. The mount of claim 11, wherein the first and second bracket legs each extend outwardly beyond both the first and second bracket flanges such that free ends of the first and second bracket legs contact a bollard post to help retain the mount in a fixed position with respect to the support structure post.

14. The mount of claim 11, wherein each of the first and second bracket flanges includes a notch, the notch of the first bracket flange coaxially aligned with the notch of the second bracket flange such that a support structure post is received within the notch of both the first and second bracket flanges when the mount is engaged with the post.

15. A mount for attaching a sign to a support structure post, the mount comprising:
a brace having first and second parallel flanges each having a plurality of apertures, individual ones of the apertures of both the first and second flanges being coaxially aligned;
first and second brackets each having a bracket web and transversely extending first and second bracket flanges, the first and second bracket flanges adapted to be slidably received between the first and second flanges of the brace and each of the first and second bracket flanges having a plurality of elongated apertures, with individual ones of the elongated apertures of both the first and second bracket flanges being coaxially aligned; and
each of the first and second bracket flanges having a notch, the notch of the first bracket flange coaxially aligned with the notch of the second bracket flange such that a support structure post is received within the notch of both the first and second bracket flanges when the mount is engaged to the post.

16. The mount of claim 15, further comprising a plurality of fasteners adapted for releasably connecting the first and second brackets to the brace, with individual ones of the fasteners inserted through individual ones of the elongated apertures which are coaxially aligned with the coaxially aligned individual ones of the apertures of both the first and second flanges.

17. A method for assembling a mount for attaching a sign to a support structure, the mount including a brace with a web and first and second flanges, and a bracket having a bracket web and first and second bracket flanges, the method comprising:
creating a plurality of apertures in each of the first and second flanges with individual ones of the apertures of the first flange coaxially aligned with individual ones of the apertures of the second flange;
forming a plurality of elongated apertures in each of the first and second bracket flanges with individual ones of the elongated apertures of the first bracket flange coaxially aligned with individual ones of the elongated apertures of the second bracket flange;
positioning the bracket having the first and second bracket flanges located between the first and second flanges of the brace and with individual ones of the elongated apertures of both the first and second bracket flanges coaxially aligned with individual ones of the coaxially aligned apertures of the first and second flanges of the brace; and
inserting a fastener through the coaxially aligned elongated apertures and brace flange apertures.

18. The method of claim 17, further comprising bending the first and second flanges transversely with respect to the web brace.

19. The method of claim 18, further comprising transversely orienting the first and second bracket flanges with respect to the bracket web.

20. The method of claim 17, further comprising:
creating a first bracket leg of the bracket oriented transverse to both the bracket web and the first and second bracket flanges, the first bracket leg including a first bracket leg elongated aperture; and
forming a second bracket leg of the bracket oriented transverse to both the bracket web and the first and second bracket flanges and substantially parallel to and side-by-side with the first bracket leg, the second bracket leg including a second bracket leg elongated aperture.

21. The method of claim 20, further comprising inserting a flexible strap through both the first and second bracket leg elongated apertures and fixedly connecting the strap about a support structure post.
